(19) United States
(12) Patent Application Publication
(10) Pub. No.: US 2006/0196886 A1
(43) Pub. Date: Sep. 7, 2006

(54) MULTIPLE BEVERAGE DISPENSING ASSEMBLY FOR VISCOUS AND FROTHED BEVERAGES

(76) Inventor: David Fox, Sylmar, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/164,998

(22) Filed: Dec. 13, 2005

Related U.S. Application Data
(63) Continuation-in-part of application No. 10/940,281, filed on Sep. 13, 2004.
Application No. 10/940,281 is a division of application No. 10/454,453, filed on Jun. 3, 2003, now Pat. No. 6,871,761.
(63) Continuation-in-part of application No. 11/004,466, filed on Dec. 3, 2004, now Pat. No. 7,070,068.

(51) Int. Cl. B67D 5/56

(52) U.S. Cl. 222/129.1

(57) ABSTRACT

A multiple dispenser assembly includes a nozzle having a plurality of beverage concentrate and diluent inlets and discharge outlets. An outer housing extends downwardly from the nozzle. The beverage concentrate inlets and outlets are configured to permit viscous beverage concentrates to pass therethrough in a selective manner. A diluent jet is disposed in fluid communication with the diluent outlet so as to direct diluent across a downward discharge axis of at least one of the discharge outlets to create a frothed beverage. Thus, the nozzle can accommodate a variety of beverage concentrate flavors and selectively froth at least one of the beverages.

### BACKGROUND OF THE INVENTION

The present invention generally relates to beverage dispensing assemblies. More particularly, the present invention relates to a multiple beverage dispensing assembly which permits passage of viscous beverage concentrates, and can enable the whipping of frothed beverages.

Due to increases in both the number of customers served and the volume of drinks dispensed by the food and drink service industry, and counter space being at a premium, standard drink dispensing nozzles fail to meet customer demand in order to reduce space requirements and also for aesthetic reasons, and thus it is desirable to dispense multiple flavors of drinks from a single nozzle.

In dispensing drinks from a nozzle, it is essential that the flavored syrup, also referred to as beverage concentrate, be mixed with a mixing fluid, typically plain or carbonated water, so that the resulting drink is of uniform consistency. One major problem encountered with multiple flavor nozzles is syrup carryover. It is very difficult to completely remove the residual syrup from a previously dispensed drink to avoid carryover into a subsequent, different flavored drink. This carryover causes problems with the flavor, the color, and the smell of dispensed drinks. Even small amounts of carryover syrup which cause only minor problems with odor and taste have a significant effect on the color of clear drinks, which is undesirable.

U.S. Pat. No. 4,928,854 to McCann is directed to a multiple flavor nozzle assembly. The syrup is delivered to the nozzle exit through a separate tubular conduit for each flavor. The syrup flows through a plurality of separate conduits to a discharge opening into a water channel for delivery to the exit end of the nozzle. However, the total surface area of syrup presented for contact with the mixing fluid is relatively small, and thus proper mixing is difficult. The configuration also makes it difficult to eliminate syrup carryover.

U.S. Pat. Nos. 6,047,859; 6,098,842; 6,321,938 and 6,345,729, all assigned to Lancer Partnership, Ltd. (Lancer), all disclose a multiple flavor beverage dispensing nozzle assembly which overcome these drawbacks. These patents are incorporated herein by reference. An embodiment of these patents is currently commercially offered by Lancer, and enables up to four distinct beverages to be dispensed through a single nozzle, as well as providing four flavor shots.

This embodiment is illustrated herein in FIGS. 1-4. The nozzle 10 includes a cap member 12 permanently affixed to an inner housing 14, which is surrounded by an outer housing or sleeve 16. As illustrated in FIG. 4, the upper surface of the cap member 12 includes a plurality of inlet ports 18 adapted to receive the beverage syrup therein. In the commercially offered embodiment, inlets 20 are also provided for flavor shots, such as concentrated vanilla, cherry, lemon, lime, etc. The commercially provided nozzle 10 enables up to four distinct beverage syrups and four distinct flavor shots to be administered by the single nozzle assembly 10. Inlet 22 is adapted to receive a diluent, such as ordinary tap water or carbonated water.

As illustrated in FIGS. 1 and 2, the nozzle assembly 10 also includes a plurality of clips 24 which are adapted to secure a conduit of the source of diluent, flavor syrup or flavor shots syrup (not shown) in place. The assembly 10 also includes a plurality of dog ears 26 for removably attaching the nozzle 10 to the beverage dispenser (not shown). The attachment of the nozzle 10 to the beverage dispenser and its conduits will be appreciated by those skilled in the art.

With reference now to FIG. 2, the cap member 12 is nonremovably attached to the inner housing 14, such as by adhesives or the like. The mixing fluid or diluent enters through inlet 22, and through a series of passageways, such as that illustrated in FIG. 5 of U.S. Pat. No. 6,047,859, and exits through a plurality of peripheral diluent outlets 28. The diluent, typically water or carbonated water, flows between the inner and outer housings 14 and 16 and is mixed with the beverage syrup concentrate as it is dispensed from the outlets of the nozzle 10. As disclosed in the aforementioned patents, preferably the water cascades over the outlets so as to clean the outlets and prevent syrup carryover between selection of different beverages.

Within the inner housing 14 is disposed a plurality of annuluses, one annulus for each syrup intake port, or a total of four in the illustrated embodiment. The three beverage arrangement, with flavor shots, is illustrated in FIG. 20 of U.S. Pat. No. 6,047,859. With reference to FIG. 3 herein, the flavor shot outlets 30 extend through a central portion of the inner housing 14, while a series of small apertures 32 representing the outlets for the four concentric passageways encircle the flavor shot outlets 30. The innermost circle or series of syrup concentrate outlets 32 correspond with a single flavor and single annulus passageway. Thus, the outlets 32 are arranged concentrically, representing the outlets for each passageway or annulus within the inner housing 14.

In operation, when a particular beverage is selected, the syrup concentrate for that beverage is dispensed into inlet 18, and into an enlarged passageway or cavity within the cap 12, and then into its corresponding annulus passageway and through the corresponding outlets 32. If a flavor shot, such as cherry or vanilla, is selected, the syrup for this flavor shot is introduced through inlet 18, through a passageway and out outlet 30. Simultaneously, the water or carbonated water is emitted through inlet 22, and out outlets 28, so as to flow over the inner housing 14, and come into contact with the syrup concentrate as it emitted from the outlet(s) 30 and/or 32.

A drawback, however, to this Lancer nozzle assembly 10 is that beverages having a relatively high viscosity cannot pass through the tortious, small annular passageways, and even smaller outlets 32. Instead, the viscous beverage concentrate becomes clogged through these passageways. This is the case for horchata beverage concentrates, fruit juice concentrates, and the like. Thus, while the Lancer multiple beverage dispensing nozzle can accommodate colas and other carbonated drinks, it cannot handle and accommodate the more viscous fruit juice-based drinks.

There also exists a class of beverages in which the beverage concentrate or syrup is violently mixed with the diluent, typically plain water, in such a manner so as to entrain bubbles therein so as to create a whipped and frothy beverage, which is appealing to the consumer. Examples of such beverages are those offered under the Bang™ trademark by Orange Bang, Inc. The beverage concentrates for these drinks are also fairly viscous, and can clog the small passageways and outlets of the Lancer nozzle.

Accordingly, there is a continuing need for a multiple flavor beverage dispensing nozzle assembly which can accommodate beverage syrup concentrates of a higher viscosity, as well as enabling the whipping or foaming of selected beverages. The present invention fulfills these needs, and provides other related advantages.

### SUMMARY OF THE INVENTION

The present is directed to a multiple beverage dispenser assembly which overcomes the drawbacks discussed above. The beverage dispenser generally comprises a nozzle having a plurality of beverage concentrate inlets and discharge outlets. The beverage concentrate inlets and discharge outlets are preferably configured to permit viscous beverage concentrates to pass therethrough. In a particularly preferred embodiment, at least one flavor syrup (flavor shot) inlet and outlet are formed in the nozzle for introducing flavor syrup into a discharged beverage.

In one embodiment, a diluent inlet of the nozzle is in communication with a diluent jet disposed so as to direct diluent across a downward discharge axis of at least one of the discharge outlets to create a frothed beverage when the diluent collides with the beverage concentrate discharged from at least one discharge outlet. That is, the diluent is projected across and through the downwardly discharged syrup concentrate and toward an outer housing which extends downwardly from the nozzle.

In a particularly preferred embodiment, a diffuser is disposed in the outer housing below the nozzle. The diffuser includes a central beverage discharge aperture, and a plurality of apertures formed adjacent to the discharge aperture which are adapted to permit air to flow upwardly therethrough.

The multiple beverage dispenser assembly of the present invention can be created by modifying an existing multiple beverage dispensing assembly, such as that provided by Lancer, to permit passage of viscous beverage concentrates and as well as enabling whipping of drinks. A multiple flavored beverage dispensing assembly is provided which includes a beverage dispensing nozzle having a cap member fixed to an inner housing. The cap member has a plurality of beverage concentrate inlets and a diluent inlet. The beverage concentrate inlets are in fluid communication with cavities for directing the beverage concentrate to an assigned channel for exit through a plurality of discharge ports at the base of the inner housing. The diluent inlet is in fluid communication with a plurality of peripheral diluent outlets. An outer housing cooperatively forms a diluent channel with the inner housing. A lower portion of the inner housing is cut and removed so as to expose the beverage concentrate cavities, which become the beverage concentrate outlets. This allows the selective dispensing of viscous beverage concentrates through the corresponding beverage concentrate inlets and associated beverage concentrate discharge cavities. This also provides sufficient space within the outer housing or sleeve so as to dispose a diffuser within the outer housing below the cut inner housing.

In a particularly preferred embodiment, the peripheral diluent outlets are sealed, and a diluent outlet is formed in a bottom surface of the cut inner housing so as to be in communication with the diluent inlet. A diluent jet is inserted into the diluent outlet, and an aperture thereof is directed toward a downward discharge axis of a discharge cavity. Thus, the diluent collides with discharged beverage concentrate to create a whipped beverage. The aperture of the diluent jet may be sufficiently elongated and configured so as to emit diluent across the downward discharge axis of at least first and second discharge cavities. Thus, the diluent collides with a first beverage concentrate as it is discharged from the first cavity to create a first frothed beverage, and collides with a second beverage concentrate as it is discharged from the second cavity to create a second frothed beverage. In this manner, two different flavored frothed drinks can be created from the same nozzle. Moreover, in the case where three or more flavored beverages can be dispensed from the nozzle, an additional one or more non-frothed beverages can also be selectively discharged from the nozzle.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a top perspective view of a prior art multiple beverage dispenser.

FIG. 2 is a partially exploded side elevational view of the nozzle of FIG. 1.

FIG. 3 is a bottom plan view taken generally along line 3-3 of FIG. 2, illustrating syrup concentrate outlets of the nozzle.

FIG. 4 is a top plan view taken generally along line 4-4 of FIG. 2, illustrating water and syrup inlets of the nozzle.

FIG. 5 is a partially exploded side elevational view of a multiple beverage nozzle assembly embodying the present invention.

FIG. 6 is a top perspective view of a nozzle of the assembly of the present invention, illustrating diluent and beverage concentrate inlets.

FIG. 7 is a bottom perspective view of a diffuser, used in accordance with the present invention.

FIG. 8 is a bottom perspective view of the nozzle of the present invention, illustrating the insertion of a diluent jet into a diluent outlet of the nozzle, in accordance with the present invention.

FIG. 9 is bottom diagrammatic view of the nozzle, illustrating diluent being sprayed across a discharge cavity in order to create a frothed beverage, in accordance with the present invention.

FIG. 10 is a bottom plan diagrammatic view similar to FIG. 9, but illustrating the jet spraying diluent across two discharge cavities to selectively create one of two foamy beverages through the same nozzle assembly.

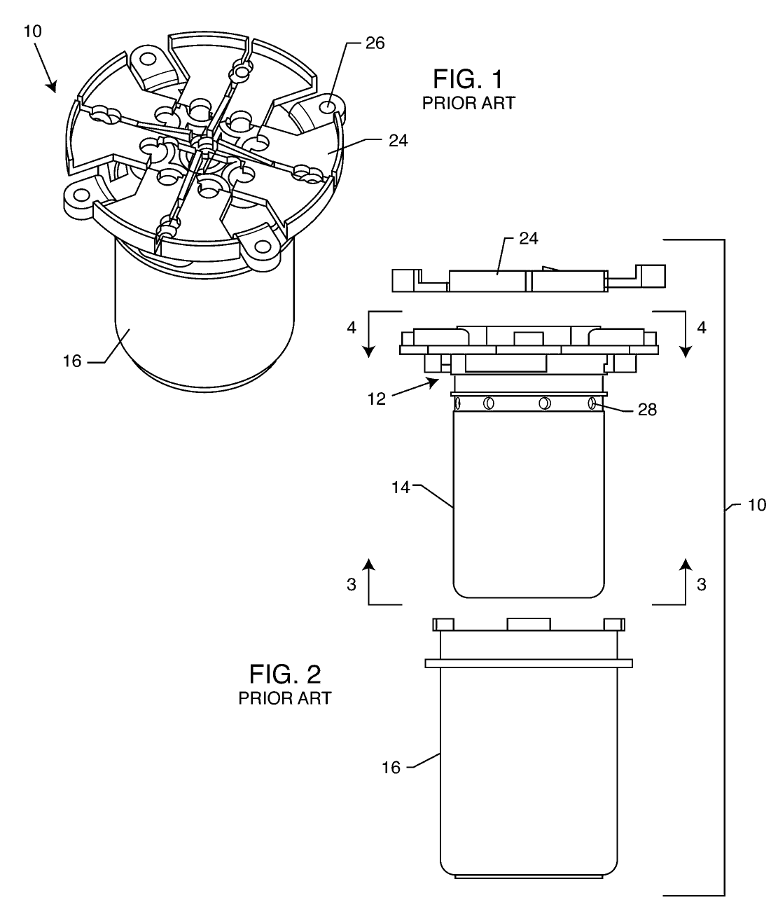

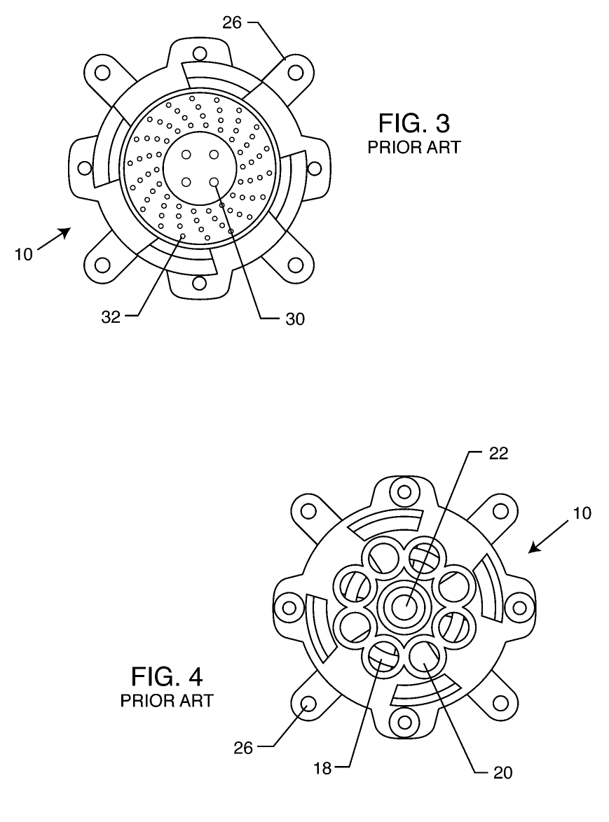

### DETAILED DESCRIPTION OF THE PREFERRED EMBODIMENTS

As shown in the accompanying drawings, for purposes of illustration, the present invention resides in a multiple beverage dispenser nozzle assembly, generally referred to by the reference number 100. The assembly 100 of the present invention is configured in such a manner so as to permit viscous beverage concentrates to pass therethrough without clogging the assembly 100. The assembly 100 can also be modified so as to dispense at least one frothed beverage, as discussed more fully herein.

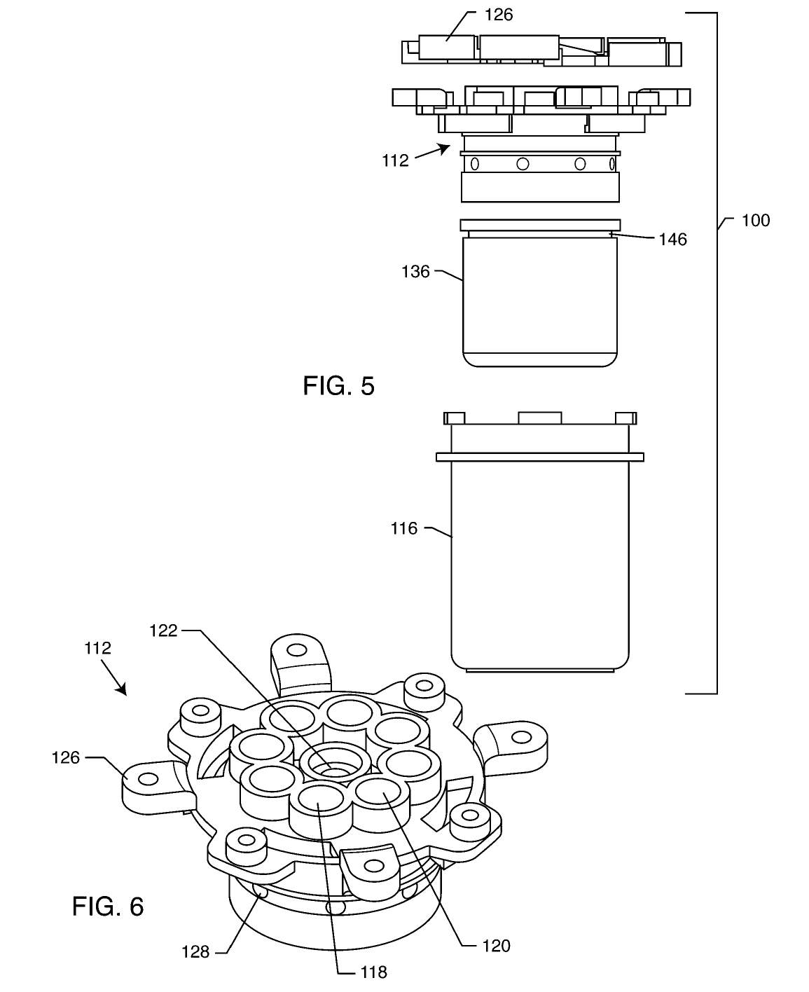

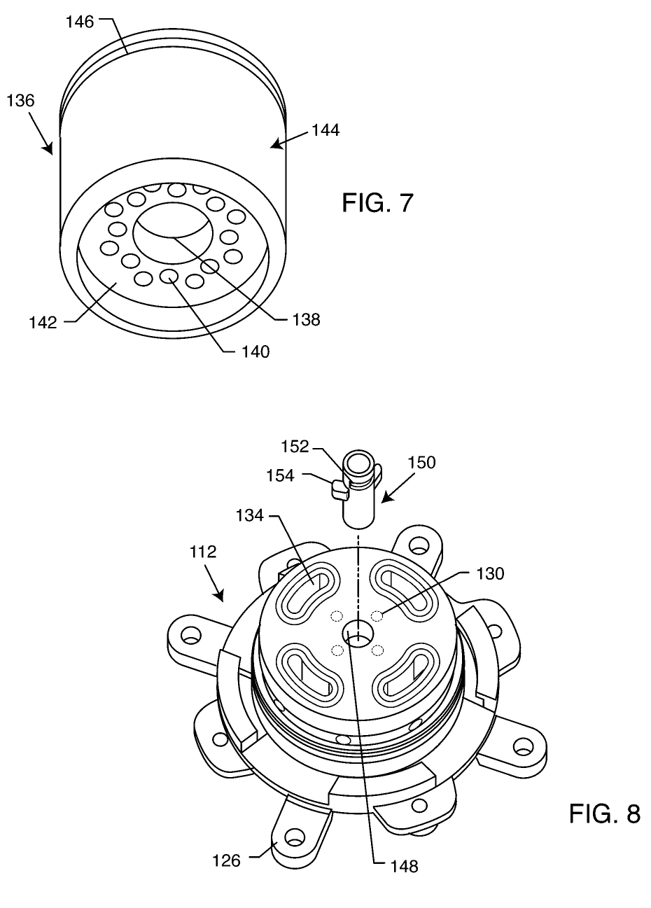

With reference now to FIG. 5, the assembly 100 of the present invention comprises a beverage dispensing nozzle 112. As illustrated in FIGS. 6 and 8, the nozzle assembly 112 includes a diluent inlet 122, and beverage concentrate or syrup inlets 118. Inlets 120 for additional syrup concentrates, such as flavor shots, may also be provided. The nozzle assembly 112 preferably includes dog ears 126 or the like for securing the nozzle 112 to a beverage dispenser (not shown). Clips 126 are also preferably provided for fastening diluent (typically regular water) and in beverage concentrate conduits (not shown) in their respective inlets 118-122.

With reference now to FIG. 8, which is a bottom perspective view of the nozzle 112, multiple discharge cavity outlets 134 are formed in the nozzle assembly 112 and in fluid communication with the beverage concentrate inlets 118. The beverage concentrate inlet 118, and the passageway to the enlarged discharge cavity outlet 134 are sufficiently large in size so as to permit viscous fluid, such as horchata and fruit juice beverage concentrates, to easily pass therethrough without clogging.

In one form of the invention, the Lancer inner housing 12, 14 assembly is modified so as to create the nozzle 112 of the present invention. As described above, the Lancer inner housing 114 includes a plurality of concentric members defining concentric passageways leading to relatively small outlets 32. However, if this bottom portion is cut and removed, typically slightly below the water outlets 28, the larger discharge cavities 134 are exposed to create outlets which can accommodate the passage of more viscous beverage concentrates. Thus, the nozzle 112 of the present invention can be created by cutting and removing a lower portion of the internal housing 14 of the Lancer nozzle so as to expose the cavities 134.

With reference again to FIG. 5, an added benefit of removing the majority of the inner housing 14 of the Lancer nozzle enables the insertion of a diffuser 136 below the nozzle 112 and within the outer housing or sleeve 116. Of course, if the nozzle 112 is manufactured instead of being a modified Lancer nozzle, it can be designed so as to be sufficiently short to permit the diffuser 136 to be inserted within the outer housing sleeve 116.

The diffuser 136 is designed so as to mix the discharged diluent or water and the discharged beverage concentrate, and direct the at least partial mixed beverage into the beverage container. It will be appreciated by those skilled in the art that some degree of mixing occurs as the water diluent and beverage concentrate falls from the assembly 100 into the cup, as well as mixing to a certain degree while beverage continues to be dispensed into the cup. However, the diffuser 136 promotes a more thorough and even mixing by forcing the diluent and concentrate into contact with one another before being discharged from the assembly 100.

In a particularly preferred embodiment, the diffuser 136 includes a central beverage discharge aperture 138 through which the beverage concentrate and diluent is directed into the cup or other beverage container. Multiple apertures 48 are formed in a bottom wall 142 of the diffuser 136, typically adjacent to the discharge aperture 138, and permit air to flow up into the diffuser 136 so as to prevent the creation of a vacuum within the assembly 100. The apertures 138 and 140 eliminate or significantly reduce the phenomenon known as “sputtering,” wherein the beverage does not flow smoothly and instead sputters and splashes, creating a mess. As will be more fully described herein, these apertures 138 and 140 also enable the replenishment of air when creating a whipped or frothed drink. Preferably, the diffuser outer wall 144 is generally cylindrical and configured and sized so as to fit within the outer housing sleeve 116, forcing the beverage concentrate and diluent to flow therethrough. A groove 146 can be formed in the outer wall 144 which can accept an O-ring or the like to create a fluid seal between the diffuser 136 and the outer housing sleeve 116.

Those skilled in the art will appreciate that the present invention, similar to the Lancer nozzle assembly, enables the selective discharge or one of multiple beverage types or flavors from the same assembly 100. However, the nozzle assembly 100 of the present invention is modified or adapted so as to permit viscous beverage concentrate flow therethrough in a selective and controlled manner. Thus, the consumer could select a horchata drink to be dispensed. The next consumer could utilize the same nozzle assembly 100 to dispense a fruit juice beverage. Of course, the horchata concentrate will flow from one inlet 118 and outlet 134, while the fruit juice beverage concentrate will flow through another inlet 118 and outlet 134, so as to never mix or come into contact with one another. As illustrated, up to four beverage types or flavors could be dispensed from the same nozzle assembly 100.

Flavor shots could also be added to the beverages, if desired, via the flavor shot concentrate inlets 120 and outlets 130. Such syrups are typically not too viscous, thus the inlets 120 and outlets 130 can be relatively small. When cutting the inner housing and cap assembly 12, 14 of the Lancer device, the flavor shot passageways are cut to expose outlets 130.

Although the diluent or water outlets 128 could be left open, and thus water or other diluent discharged therefrom so as to mix with the beverage concentrate, this will not enable the creation of whipped or frothy drinks. This is due to the fact that specially constituted beverage concentrates must be violently mixed with the water diluent in order to entrain air and create a frothed drink. In order to accomplish this, as illustrated in FIG. 8, the peripheral diluent outlets 128 are sealed, and a diluent outlet 148 is formed in the bottom surface of the nozzle 112. This outlet 148 is in fluid communication with the diluent inlet 122. The diluent outlet 148 is of a sufficiently large diameter so as to enable the insertion of a diluent jet 150 therein. The diluent jet 150, as explained in detail in U.S. patent application Ser. No. 10/454,453 (incorporated by reference herein) is a hollow member having an opening 152, preferably a slit or series of apertures. The pressurized water is forced through this slit 152 so as to spread outwardly away from the jet 150 under high pressure. Typically, the jet 150 includes projections 154 which set the jet 150 at the appropriate depth within the nozzle 112, and enable the manual insertion and removal of the jet 150 therefrom.

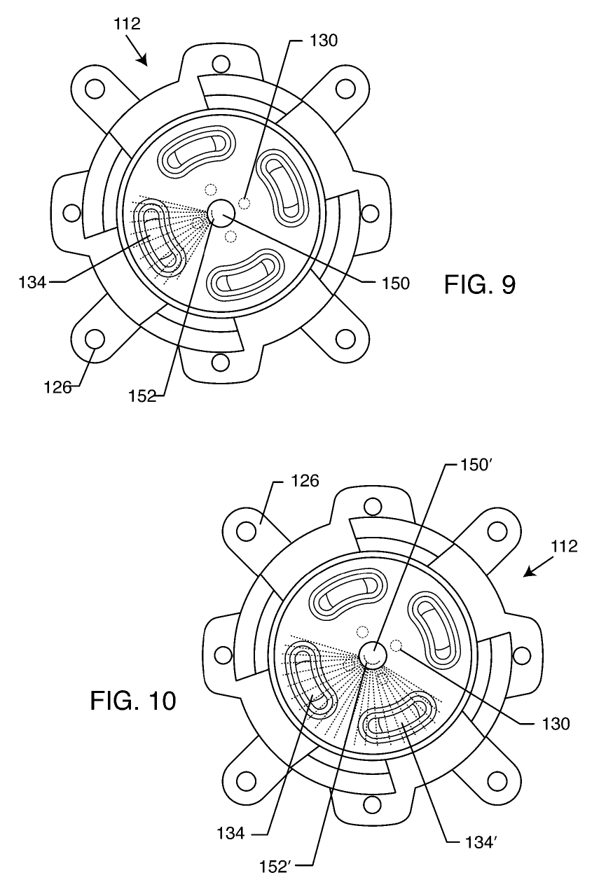

With reference now to FIG. 9, a diagrammatic view of the jet 150 spraying water diluent (illustrated by the dashed lines) over the downward discharge axis of discharge cavity 134. As beverage concentrate is dispensed from the discharge cavity 134, it will come into contact with the sprayed diluent. As this is contained within the outer housing sleeve 116, a violent mixture occurs between the diluent and the discharged beverage concentrate, causing air bubbles to be entrained in the mixture to create a frothy beverage. This beverage is dispensed through the diffuser outlet aperture 138. As air is entrained into the dispensed beverage, additional air can be replenished through apertures 140, or even 138 of the diffuser 136.

With reference now to FIG. 10, a diluent jet 150′ can be selected having an elongated slit or a longer series of apertures 152′. The slit 152′ is directed and oriented such that the diluent emitted from the jet 150′ spreads across two of the discharge cavities 134 and 134′. Of course, it is appreciated that the sprayed water is actually directed transverse to a downward discharge axis of the discharge cavities 134, 134′ such that the diluent collides with the discharged beverage concentrate to create a frothed beverage. However, in this case, up to two frothed beverage drinks can be dispensed from the same nozzle assembly 100. That is, due to the fact the beverage concentrate is emitted only from a single beverage discharge cavity 134 at any given time, the diluent will mix with the discharged beverage concentrate. Thus, beverages of two distinct flavors which are desirably whipped or frothed, can be dispensed from the same nozzle assembly 100. Of course, the invention could be adapted such that two beverage concentrates are emitted simultaneously to create a combination flavor if so desired. The remaining cavity discharge outlets 134 could still dispense non-whipped beverage concentrates, which would be mixed with a diluent as the diluent and concentrate passes through the diffuser 136. Due to the composition of the beverage concentrate, as well as the fact that the diluent would not be sprayed directly into the concentrate, but rather against the inner wall of the outer housing sleeve 116 so as to flow into contact with the emitted beverage concentrate, the beverage concentrate will not be whipped or become frothy.

Although several embodiments have been described in detail for purposes of illustration, various modifications may be made without departing from the scope and spirit of the invention. Accordingly, the invention is not to be limited, except as by the appended claims.

What is claimed is:

1. A process for modifying a multiple beverage dispensing assembly to permit passage of viscous beverage concentrates and enable whipping of drinks, the process comprising the steps of:
providing a multiple flavor beverage dispensing assembly including a beverage dispensing nozzle having a cap member fixed to an inner housing, the cap member having a plurality of beverage concentrate inlets and a diluent inlet, the beverage concentrate inlets being in fluid communication with cavities for directing the beverage concentrate to an assigned channel for exit through a plurality of discharge ports at the base of the inner housing, the diluent inlet being in fluid communication with a plurality of peripheral diluent outlets, and an outer housing cooperatively forming a diluent channel with the inner housing;
cutting and removing a lower portion of the inner housing so as to expose the beverage concentrate cavities; and
selectively dispensing viscous beverage concentrates through the corresponding beverage concentrate inlets and associated beverage concentrate discharge cavities.

2. The process of claim 1, including the step of disposing a diffuser within the outer housing below the cut inner housing.

3. The process of claim 2, wherein the diffuser includes a central beverage discharge aperture and a plurality of apertures formed adjacent to the discharge aperture.

4. The process of claim 3, wherein the apertures adjacent to the discharge aperture are adapted to permit air to flow upwardly therethrough.

5. The process of claim 1, including the step of sealing the peripheral diluent outlets, and forming a diluent outlet in a bottom surface of the cut inner housing in communication with the diluent inlet.

6. The process of claim 5, including the step of inserting a diluent jet in the diluent outlet.

7. The process of claim 6, including the step of directing an aperture of the diluent jet towards a downward discharge axis of a discharge cavity, whereby diluent collides with discharged beverage concentrate to create a frothed beverage.

8. The process of claim 6, wherein the diluent jet aperture is configured to emit diluent across the downward discharge axis of at least first and second discharge cavities, wherein diluent collides with a first beverage concentrate as it is discharged from the first cavity to create a first frothed beverage, and wherein diluent collides with a second beverage concentrate as it is discharged from the second cavity to create a second frothed beverage.

9. A multiple beverage dispenser assembly, comprising:
a nozzle having a plurality of beverage concentrate inlets and discharge outlets;
a diluent inlet in communication with a diluent jet disposed so as to direct diluent across a downward discharge axis of at least one of the discharge outlets to create a frothed beverage when the diluent collides with the beverage concentrate discharged from the at least one discharge outlet; and
an outer housing extending downwardly from the nozzle.

10. The assembly of claim 9, wherein the beverage concentrate inlets and discharge outlets are configured to permit viscous beverage concentrates to pass therethrough.

11. The assembly of claim 9, including a diffuser disposed in the outer housing below the nozzle.

12. The assembly of claim 11, wherein the diffuser includes a central beverage discharge aperture and a plurality of apertures formed adjacent to the discharge aperture.

13. The process of claim 12, wherein the apertures adjacent to the discharge aperture are adapted to permit air to flow upwardly therethrough.

14. The process of claim 9, including at least one flavor syrup inlet and outlet formed in the nozzle for introducing flavor syrup into a discharged beverage concentrate.

15. A multiple beverage dispenser assembly, comprising:
a nozzle having a plurality of beverage concentrate inlets and discharge outlets, and a diluent inlet and outlet;
an outer housing extending downwardly from the nozzle; and
a diffuser disposed in the outer housing below the nozzle.

16. The assembly of claim 15, wherein the beverage concentrate inlets and discharge outlets are configured to permit viscous beverage concentrates to pass therethrough.

17. The assembly of claim 15, wherein the diffuser includes a central beverage discharge aperture and a plurality of apertures formed adjacent to the discharge aperture.

18. The process of claim 17, wherein the apertures adjacent to the discharge aperture are adapted to permit air to flow upwardly therethrough.

19. The assembly of claim 15, including a diluent jet in fluid communication with the diluent outlet so as to direct diluent across a downward discharge axis of at least one of the discharge outlets to create a frothed beverage when the diluent collides with the beverage concentrate discharged from the at least one discharge outlet.

20. The process of claim 15, including at least one flavor syrup inlet and outlet formed in the nozzle for introducing flavor syrup into a discharged beverage concentrate.
